(19) United States
(12) Patent Application Publication
(10) Pub. No.: US 2026/0236465 A1
(43) Pub. Date: Aug. 13, 2026

(54) AUTONOMOUS INDEX SELECTION IN A VECTORIZED DATA STORE

(71) Applicant: Teradata US, Inc., San Diego, CA (US)

(72) Inventor: Artur Borycki, San Marco, CA (US)

(73) Assignee: Teradata US, Inc., San Diego, CA (US)

(21) Appl. No.: 19/256,125

(22) Filed: Jun. 30, 2025

Related U.S. Application Data
(60) Provisional application No. 63/756,842, filed on Feb. 11, 2025.

(51) Int. Cl. G06F 16/2453; G06F 16/22; G06F 16/2455

(52) U.S. Cl. CPC G06F 16/2453; G06F 16/2237; G06F 16/24556

(57) ABSTRACT

A system may include a storage device. The storage device may store vectorized data representative of a set of data. The system may include at least one processor in communication with the storage device. The at least one processor may receive a request on the vectorized data. The at least one processor may determine if a plurality of indexes on the vectorized data exist. The at least one processor may, in response to the determination of existence of at least one index on the vectorized data, select an index from the plurality of indexes based on characteristics of each index of the plurality of indexes as applied to the request. The processor may execute the request using the selected index. A method and computer-readable medium are also disclosed.

### CLAIM OF PRIORITY

This application claims the benefit of priority under 35 U.S.C. § 119(e) of U.S. Provisional Patent Application Ser. No. 63/756,842 filed on Feb. 11, 2025, which is hereby incorporated by reference herein in its entirety.

### BACKGROUND

While traditional data store management systems allow analytics to be applied in order to gain deeper understanding about data stored in the data store, vector stores have allowed even more extensive analytics to be performed. In contemporary vector stores and vector databases, users are compelled to make upfront decisions regarding the type of index to create and subsequently select during the retrieval process. This necessitates a priori knowledge of: a) The appropriate index type to utilize; b) The inclusion of reranking logic in the code, depending on whether a similarity index or full-text search is employed; and c) Whether a full index is required or if a smaller index, constructed on a subset of the data, would suffice. These are signification limitations and can be both a complex and error-prone process. Furthermore, typical systems often restrict users to a single index per column, limiting flexibility and efficiency.

Because of these limitations, it would be desirable to allow a system to automatically select a vector index to optimize execution of a data store request.

### SUMMARY

According to one aspect of the disclosure, a system may include a storage device. The storage device may store vectorized data representative of a set of data. The system may include at least one processor in communication with the storage device. The at least one processor may receive a request on the vectorized data. The at least one processor may determine if a plurality of indexes on the vectorized data exist. The at least one processor may, in response to the determination of existence of at least one index on the vectorized data, select an index from the plurality of indexes based on characteristics of each index of the plurality of indexes as applied to the request. The processor may execute the request using the selected index.

According to another aspect of the disclosure, a method may include receiving, with a processor, a request on the vectorized data stored in a storage device. The method may include determining, with the processor, if a plurality of indexes on the vectorized data exist. The method may include in response to the determination of existence of at least one index on the vectorized data, selecting, with the processor, an index from the plurality of indexes based on characteristics of each index of the plurality of indexes as applied to the request. The method may include executing, with the processor, the request using the selected index.

According to another aspect of the disclosure, a non-transitory computer-readable medium may be encoded with a plurality of instructions executable by a processor. The plurality of instructions may include at least one processor in communication with the storage device. The plurality of instructions may include instructions to receive a request on vectorized data stored in a storage device. The plurality of instructions may include instructions to determine if a plurality of indexes on the vectorized data exist. The plurality of instructions may include instructions to select, in response to the determination of existence of at least one index on the vectorized data, an index from the plurality of indexes based on characteristics of each index of the plurality of indexes as applied to the request. The plurality of instructions may include instructions to execute the request using the selected index.

### BRIEF DESCRIPTION OF THE DRAWINGS

The disclosure may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a block diagram of an example analytic environment.

FIG. 2 is a detailed block diagram of a processing node.

FIG. 3 is a detailed block diagram of an optimizer module.

FIG. 4 is a detailed block diagram of a parser module.

FIG. 5 is a block diagram of index creation for vectorize data.

FIG. 6 is an operational flow diagram of index selection of a vectorized index.

FIG. 7 is an operational flow diagram of detailed index selection of a vectorized index.

### DETAILED DESCRIPTION OF THE FIGURES

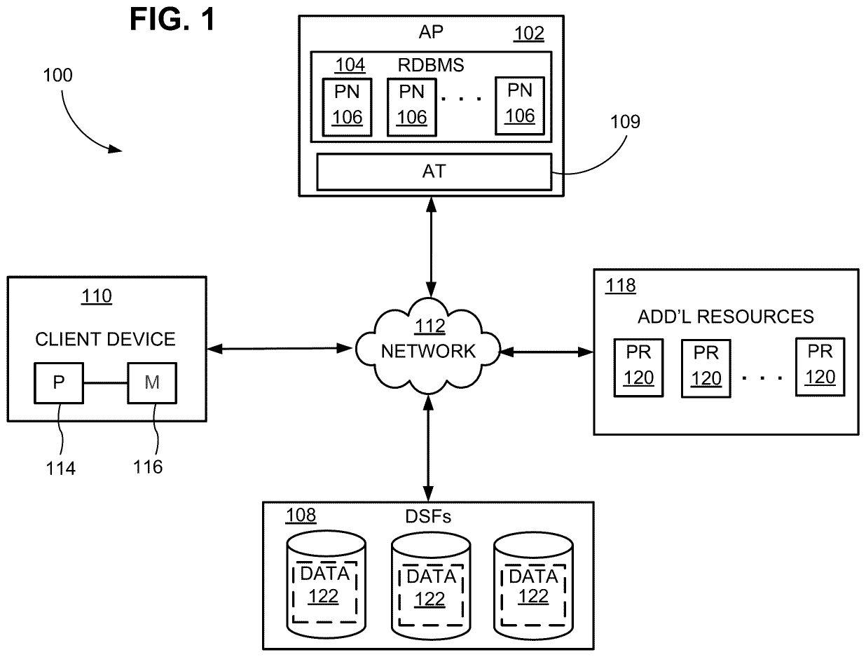

FIG. 1 is a block diagram of an example analytic environment 100. In one example, the analytic environment 100 may include an analytic platform (“AP”) 102, such as Teradata Vantage. The analytic platform 102 may include one or more systems that may be used independently or with one another in conducting advanced analytics. The analytic platform 102 may include a relational database management system (“RDBMS”) 104. In one example, the RDBMS 104 may implement a parallel-processing environment to conduct database management. The RDBMS 104 may be a combination of software (e.g., computer program routines, subroutines, applications, etc.) and hardware (e.g., processors, memory, etc.). In the example of FIG. 1, the RDBMS 104 may be a massively parallel processing (MPP) system having a number of processing nodes 106. In alternative examples, the RDBMS 104 may implement a single processing node, such as in a symmetric multiprocessing (SMP) system configuration. The RDBMS 104 may include one or more processing nodes 106 used to manage the storage, retrieval, and manipulation of data in data storage facilities (DSFs) 108. The DSFs 108 may represent various types of storage, such as persistent and/or non-persistent, for example. The processing nodes 106 may manage the storage, retrieval, and manipulation of data included in a database.

The analytic environment 100 may include a client device 110 that communicates with the analytic platform 102 via a network 112. The client device 110 may represent one or more devices, such as a graphical user interface (“GUI”), that allows user input to be received. The client device 110 may include one or more processors 114 and memory(ies) 116. The network 112 may be wired, wireless, or some combination thereof. The network 112 may be a cloud-based environment, virtual private network, web-based, directly-connected, and/or some other suitable network configuration. In one example, the client device 110 may run a dynamic workload manager (DWM) client (not shown).

The analytic environment 100 may also include additional resources 118. Additional resources 118 may include processing resources (“PR”) 120. In a cloud-based network environment, the additional resources 118 may represent additional processing resources that allow the analytic platform 102 to expand and contract processing capabilities as needed.

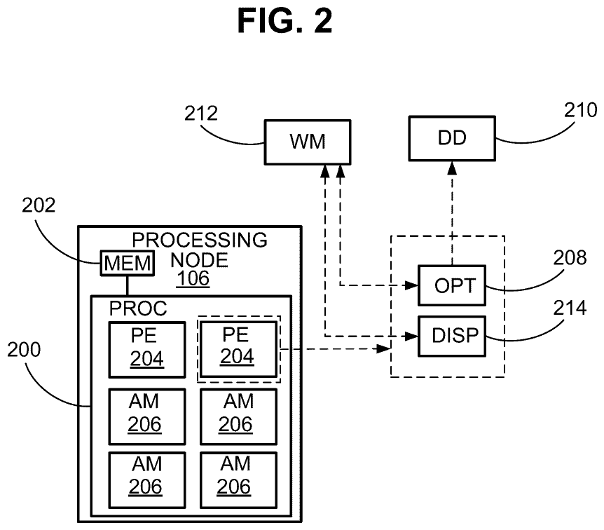

FIG. 2 is an example of a processing node 106, which may include one or more physical processors 200 and memory(ies) 202. Memory(ies) 202 may include one or more memories and may be computer-readable storage media or memories, such as a cache, buffer, random access memory (RAM), removable media, hard drive, flash drive or other computer-readable storage media. Computer-readable storage media may include various types of volatile and nonvolatile storage media. Various processing techniques may be implemented by the processors 200 such as multiprocessing, multitasking, parallel processing, and the like, for example.

The processing nodes 106 may include one or more other processing unit types such as parsing engine (PE) modules 204 and access modules (AM) 206. As described herein, each module, such as the parsing engine modules 204 and access modules 206, may be hardware or a combination of hardware and software. For example, each module may include an application specific integrated circuit (ASIC), a Field Programmable Gate Array (FPGA), a circuit, a digital logic circuit, an analog circuit, a combination of discrete circuits, gates, or any other type of hardware or combination thereof. Alternatively, or in addition, each module may include memory hardware, such as a portion of the memory 202, for example, which includes instructions executable with the processor 200 or other processor to implement one or more of the features of the module. When any one of the modules includes the portion of the memory 202 that comprises instructions executable with the processor, the module may or may not include the processor. In some examples, each module may just be the portion of the memory 202 or other physical memory that comprises instructions executable with the processor 200 or other processor to implement the features of the corresponding module without the module including any other hardware. Because each module includes at least some hardware even when the included hardware comprises software, each module may be interchangeably referred to as a hardware module, such as the parsing engine hardware module or the access hardware module. The access modules 206 may be access modules processors (AMPs), such as those implemented in the Teradata Vantage analytic platform, for example.

The parsing engine modules 204 and the access modules 206 may each be virtual processors (vprocs) and/or physical processors. In the case of virtual processors, the parsing engine modules 204 and access modules 206 may be executed by one or more physical processors, such as those that may be included in the processing nodes 106. For example, in FIGS. 1-2, each parsing engine module 204 and access module 206 is associated with a respective processing node 106 and may each be executed as one or more virtual processors by physical processors 200 included in the respective processing node 106.

In FIG. 2, each processing node 106 is shown as including multiple parsing engine modules 204 and access modules 206, such that there are more parsing engine modules 204 and access modules 206 than processing nodes 106. In one example, during operation, the one or more physical processors 200 included in the processing nodes 106 may execute the parsing engine modules 204 and access modules 206 by switching between the executions of the various modules at a rapid rate allowing the vprocs to substantially operate in “parallel.”

The RDBMS 104 stores data 122 in one or more tables (or other data object formats) in the DSFs 108. In one example, the data 122 may represent rows of stored tables that are distributed across the DSFs 108 and in accordance with their primary index. The primary index defines the columns of the rows that are used for calculating a hash value. The function that produces the hash value from the values in the columns specified by the primary index is called the hash function. Some portion, possibly the entirety, of the hash value is designated a “hash bucket.” The hash buckets are assigned to DSFs 108 and associated access modules 206 by a hash bucket map. The characteristics of the columns chosen for the primary index determine how evenly the rows are distributed.

Rows of each stored table may be stored across multiple DSFs 108. Each parsing engine module 204 may organize the storage of data and the distribution of table rows. The parsing engine modules 204 may also coordinate the retrieval of data from the DSFs 108 in response to queries received, such as those received from a client system 108 connected to the RDBMS 104 through connection with a network 112.

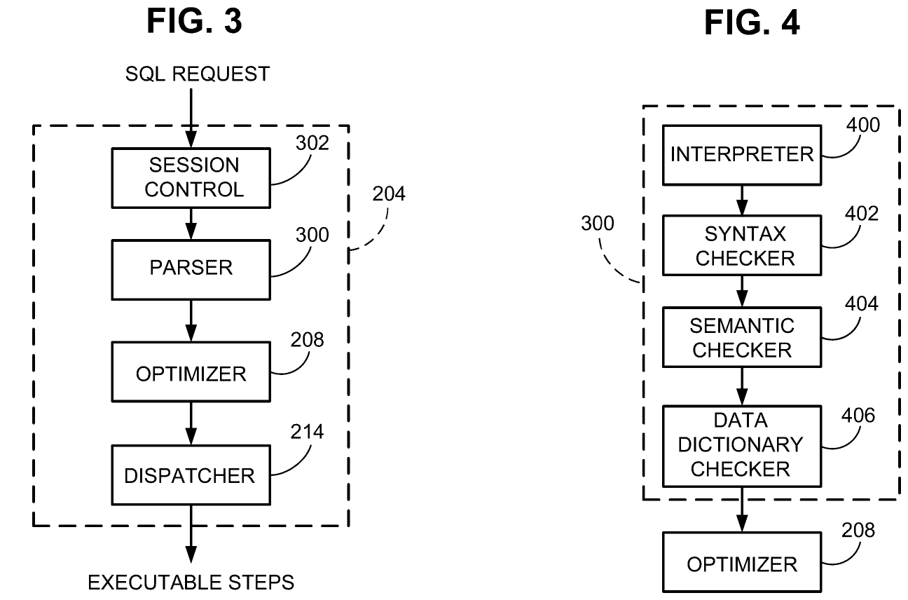

Each parsing engine module 204, upon receiving an incoming database query may apply an optimizer module 208 to assess the best plan for execution of the query. An example of an optimizer module 208 is shown in FIG. 2 with regard to a parsing engine module 204. Additional description of the parsing engine modules 204 is provided with regard to FIGS. 3 and 4. Selecting the optimal query-execution plan may include, among other things, identifying which of the processing nodes 106 are involved in executing the query and which database tables are involved in the query, as well as choosing which data-manipulation techniques will serve best in satisfying the conditions of the query. To this end, for each parsing engine module 204, a parser module 300 (see FIG. 3), and/or optimizer module 208 may access a data dictionary module 210, shown in FIG. 2 specifically for parsing engine module 204 for purposes of illustration.

The data dictionary module 210, which may reside in the RDBMS 104, may specify the organization, contents, and conventions of one or more databases, such as the names and descriptions of various tables maintained by the RDBMS 104 as well as fields/columns of each database, for example. Further, the data dictionary module 210 may specify the type, length, and/or other various characteristics of the stored tables. The RDBMS 104 typically receives queries in a standard format, such as the structured query language (SQL) put forth by the American National Standards Institute (ANSI). However, other languages and techniques, such as contextual query language (CQL), data mining extensions (DMX), and multidimensional expressions (MDX), graph queries, analytical queries, machine learning (ML), large language modes (LLM) and artificial intelligence (AI), for example, may be implemented in the RDBMS 104 separately or in conjunction with SQL. The data dictionary 210 may be stored in the DSFs 108 or some other storage device and selectively accessed.

The RDBMS 104 may include a workload management system workload management (WM) module 212, which may be executed within the RDBMS 104 by one or more processing nodes 106. The WM module 212 may be implemented as a “closed-loop” system management (CLSM) architecture capable of satisfying a set of workload-specific goals. In other words, the RDBMS 104 is a goal-oriented workload management system capable of supporting complex workloads and capable of self-adjusting to various types of workloads. The WM module 212 may communicate with each optimizer module 208, as shown in FIG. 2, and is adapted to convey a confidence threshold parameter and associated parameters to the optimizer module 208 in communication. Further, the WM module 212 may communicate with a dispatcher module 214 of each parsing engine module 206 (as shown in detail in FIG. 2 for parsing engine module 206) to receive query execution plan costs therefrom, and to facilitate query exception monitoring and automated modifications of confidence threshold parameters in accordance with disclosed embodiments.

The WM module 212 operation has four major phases: 1) assigning a set of incoming request characteristics to workload groups, assigning the workload groups to priority classes, and assigning goals (referred to as Service Level Goals or SLGs) to the workload groups; 2) monitoring the execution of the workload groups against their goals; 3) regulating (e.g. adjusting and managing) the workload flow and priorities to achieve the SLGs; and 4) correlating the results of the workload and taking action to improve performance. In accordance with disclosed embodiments, the WM module 212 is adapted to facilitate control of the optimizer module 208 pursuit of robustness with regard to workloads or queries.

An interconnection (not shown) allows communication to occur within and between each processing node 106. For example, implementation of the interconnection provides media within and between each processing node 106 allowing communication among the various processing units. Such communication among the processing units may include communication between parsing engine modules 204 associated with the same or different processing nodes 106, as well as communication between the parsing engine modules 204 and the access modules 206 associated with the same or different processing nodes 106. Through the interconnection, the access modules 206 may also communicate with one another within the same associated processing node 106 or other processing nodes 106.

The interconnection may be hardware, software, or some combination thereof. In instances of at least a partial-hardware implementation the interconnection, the hardware may exist separately from any hardware (e.g., processors, memory, physical wires, etc.) included in the processing nodes 106 or may use hardware common to the processing nodes 106. In instances of at least a partial-software implementation of the interconnection, the software may be stored and executed on one or more of the memories 202 and processors 200 of the processing nodes 106 or may be stored and executed on separate memories and processors that are in communication with the processing nodes 106. In one example, the interconnection may include multi-channel media such that if one channel ceases to properly function, another channel may be used. Additionally, or alternatively, more than one channel may also allow distributed communication to reduce the possibility of an undesired level of communication congestion among processing nodes 106.

In one example system, each parsing engine module 206 includes three primary components: a session control module 302, a parser module 300, and the dispatcher module 214 as shown in FIG. 3. The session control module 300 provides the logon and logoff functions. It accepts a request for authorization to access the database, verifies it, and then either allows or disallows the access. Once the session control module 302 allows a session to begin, a SQL request may be received such as through submission the client device 110 and the SQL request is routed to the parser module 300.

As illustrated in FIG. 4, the parser module 300 may include an interpreter module 400 that interprets the SQL request. The parser module 300 may also include a syntax checker module 402 that checks the request for correct SQL syntax, as well as a semantic checker module 404 that evaluates the request semantically. The parser module 302 may additionally include a data dictionary checker 406 to ensure that all of the objects specified in the SQL request exist and that the user has the authority to perform the request. The parsing engine module 206 implements the optimizer module 208 to select the least expensive plan to perform the request, and the dispatcher 214 coordinates the runtime execution of executable steps of the query execution plan of the optimizer module 208 with the access modules 206.

In one example, to facilitate implementations of automated adaptive query execution strategies, such as the examples described herein, the WM module 212 monitoring takes place by communicating with the dispatcher module 214 as it checks the query execution step responses from the access modules 206. The step responses include the actual cost information, which the dispatcher module 214 may then communicate to the WM module 212 which, in turn, compares the actual cost information with the estimated costs of the optimizer module 208.

Vectorizing data into vector embeddings allows deeper analytical techniques to be applied to data. Such techniques may include the use of artificial intelligence (“AI”) and/or large language models (“LLMs”). These techniques allow a variety of tasks to be accomplished, such as text similarity tools to be applied over voluminous amounts of data, for example. However, because of the complexity of analyzing vector embeddings, techniques to expedite this process are needed in order to conduct analyses within reasonable times. Similar to traditional data store table analysis techniques, indexes may be used on vector embeddings.

While indexes are traditionally created upon able creation, this is a more difficult proposition with regard to vectorized data. Because indexes are computationally time-consuming, resources may not always be available to create an index immediately. Numerous indexing techniques exist for vectorized data, which do not normally exist for traditional data stores, such as those having SQL tables. Moreover, each of these indexing techniques may offer advantages with regard to one another depending on the desired outcome. Additionally, the vector indexes may be created based on other conditions, such as amount of data on which the indexes are created, which may be based on data type or time, for example. Thus, enhancing the intelligence of the RDBMS 104 to create vector indexes ahead of time in order for them to be readily available, while adding selection ability, so that the optimal index may be used in the execution of a request on the RDBMS 104 will improve response time to queries and/or other requests.

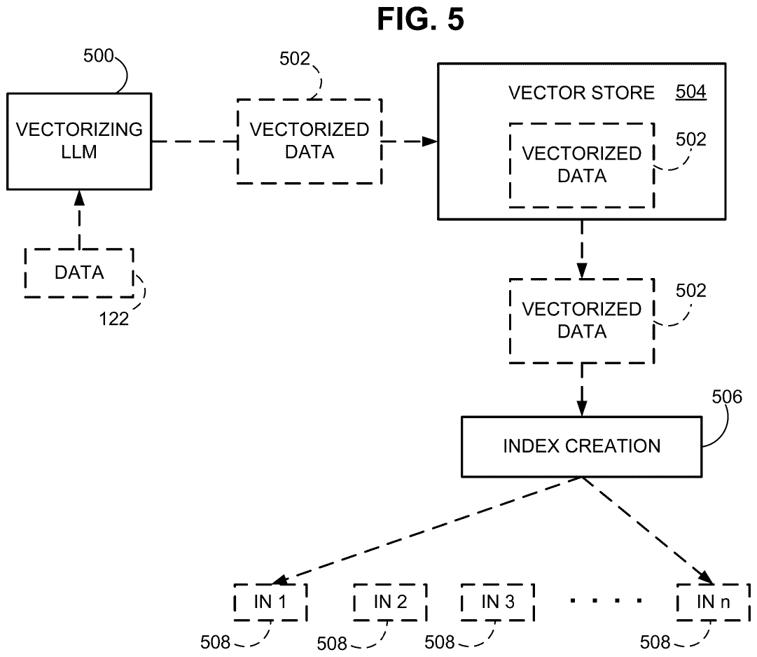

FIG. 5 is an example of the creation of multiple indexes on a vector store. In one example, data 122, such as that stored in DSFs 108 may be vectorized. As shown in FIG. 5, at least a portion of data 122 may be input into a vectorizing LLM 500. The vectorizing LLM 500 may be a pre-trained LLM capable of generating the necessary vector data to accurately represent the data 122. The output of the vectorizing LLM, vectorized data 502, (i.e. vector embeddings) may be stored in vector store 504, which may be a dedicated part of the DSFs 108 or may represent other storage facilities and/or storage techniques.

Various vector index types may be generated on the vectorized data 502, such as flat indexing, Locality Sensitive Hashing (“LSH”) indexes and inverted file (“IVF”) indexes, for example. Because indexes are typically computationally expensive to generate, once created, updates to the indexes occur judiciously. As shown in FIG. 5, index creation 506 may be applied to the vectorized data 502, which may include some or all of the vectorized data 502 for each index created. As shown in the example of FIG. 5, indexes 508 (designated individually as IN 1 through IN n) are created through the index creation 506. The index creation 506 may occur within the RDBMS 104 or may be performed externally. Each index 508 may be stored within the RDBMS 104.

While these indexes may be beneficial to use regarding queries/requests on the vectorized data 502, a user may still be tasked with selecting the index that would maximize performance and accuracy of the query results. Thus, there is a current gap in system intelligence between creation of the indexes and which is the optimal candidate to be applied. Moreover, vector indexes may be created using various conditions, based on temporal considerations (specifically, specific windows of time) or subsets of vectorized data sets, for example.

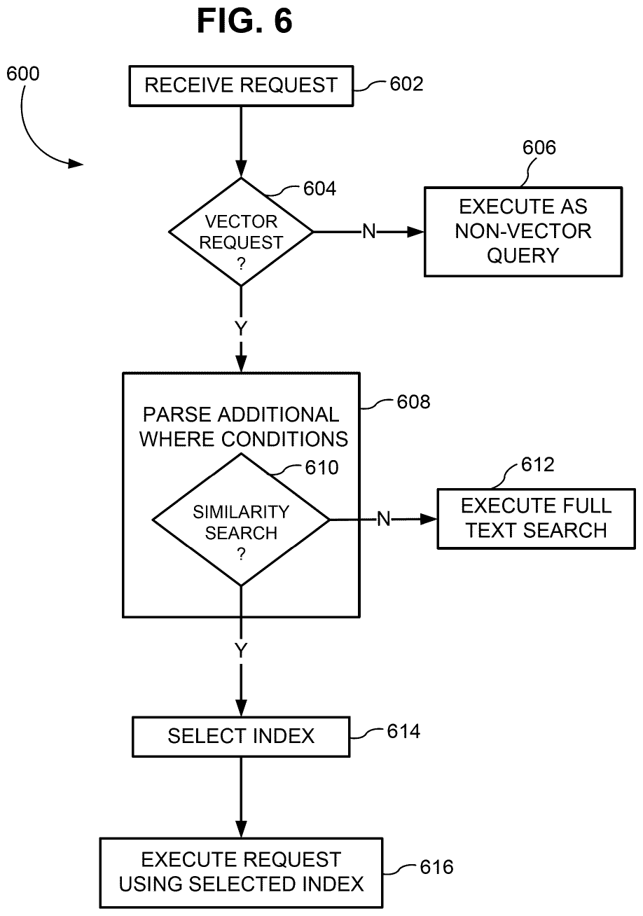

FIG. 6 is an operational flow diagram 600 of an example of a technique to be applied in determining if vector indexes are available and, if so, which would be the optimal one to use. In one example, the RDBMS 104 may receive a request (e.g., a query) via client device 110 or other device capable of communication with the RDBMS 104 (602). The RDBMS 104 may determine if the request is associated with vectorized data 502 (604). If the request is not directed to vectorized data 502, the request may be executed as a non-vector-based query (606).

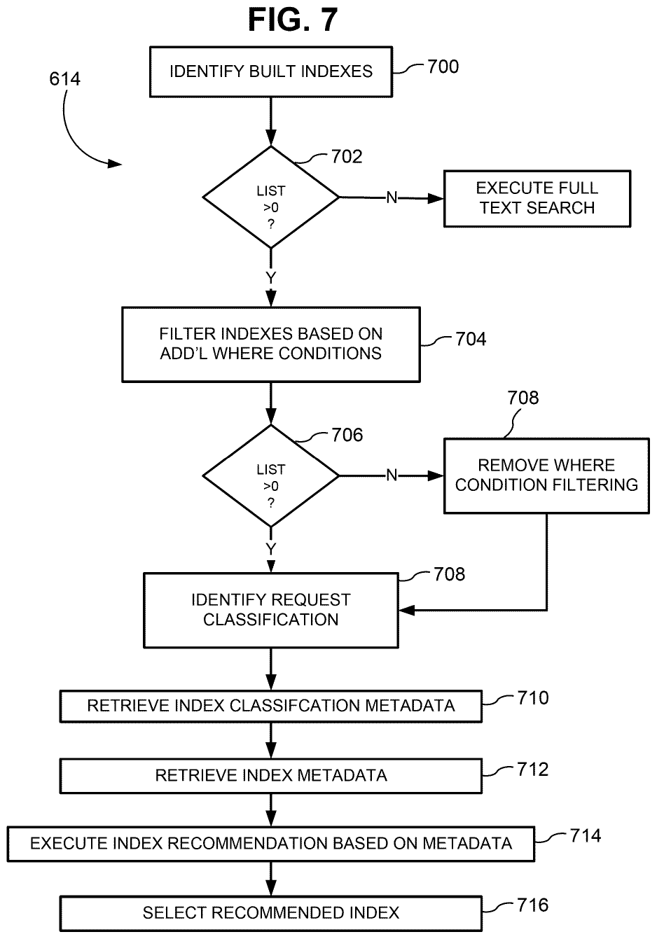

If the request is determined to be directed towards the vectorized data 502 (604), the RDBMS 104 may parse additional WHERE conditions contained in the request (608). Within the parsing (608), the RDBMS 104 may determine if a similarity search is desired based on the language of the request (610). For example, a request may include a statement such as “Select * from table where text=‘Question text’”. This would imply that the request seeks a full text search, as opposed to a similarity search, as the request uses an equal signing representing an exact text search. Parsing of that request would allow the RDBSM 104 to decide to use full text search index for faster return of results (60). If the request includes a statement, such as the example “Select * from table WHERE text like ‘Question’”, the implication is that the request seeks a similarity search, which may require additional details to determine which of the indexes may provide the optimal performance regarding the request. If a similarity search is to be executed (606), the RDBMS 104 may perform index selection (610), the details of which are further described in FIG. 7. Upon selection of the index 508, the RDBMS 104 may execute the request using the selected index 508 (612).

With regard to index selection, a classification system may be applied across the indexes to allow categories of comparison to be used by the RDBMS 104 when choosing indexes. In one example, metadata on each created index 508 may be maintained using the following non-exhaustive list of classification categories:
Index Type—Flat Index, HNSW, IVF, LSH, tree-based, etc.
Memory Usage—Amount of memory used when applying the index.
Quality—Accuracy and relevance of search results, measured through multiple dimensions:
   Recall metrics—Percentage of true nearest neighbors retrieved in top-k results. Exact indexes achieve 100% recall, while approximate indexes trade recall for speed (typically 85-99% for production systems).
   Precision at K—Relevance of returned results at different cutoff points (P@1, P@5, P@10). Important for applications where only top results matter.
   Query-specific Quality: Some vector distributions or query patterns may perform better/worse with specific index types. Evaluation across representative query sets is essential.
   Quality-Speed Tradeoffs: Most approximate indexes offer configurable parameters (e.g., ef_construction, ef_search in HNSW; nprobe in IVF) allowing runtime adjustment of quality versus performance.
   Distance Preservation: How well the index preserves semantic relationships encoded in the original vector space, especially important for downstream applications relying on distance rankings.
Performance—Latency and throughput requirements that define acceptable system behavior:
   Query Latency Percentiles: Target response times (p50, p95, p99) for individual queries. Typical ranges from sub-millisecond for cached results to 10-100 ms for complex searches across large datasets.
   Throughput Requirements: Queries per second (QPS) the system must handle. Affects choice between indexes optimized for single-query latency versus batch processing efficiency.
   Concurrent Query Handling: How performance degrades under concurrent load. Some indexes handle parallelization better due to read-only operations versus those requiring locks or coordination.
   Cold Start Performance: Initial query performance when index is not warmed in cache versus steady-state performance after thermal optimization.
   Scalability Characteristics: How performance changes with dataset growth, including both index build time and query performance degradation patterns.
   Resource Utilization: CPU, memory bandwidth, and cache efficiency during query processing, affecting overall system capacity planning.
Dimensionality—The vector space characteristics that fundamentally impact index design and performance:
   Curse of Dimensionality: As dimensions increase beyond 100-1000, distance metrics become less discriminative, and many indexing strategies lose effectiveness. Requires specialized high-dimensional techniques.
   Intrinsic versus Extrinsic Dimensionality: Actual vector dimensions vs effective dimensionality of the data manifold. Data often lies on lower-dimensional manifolds within high-dimensional spaces.
   Dimension-specific Optimizations: Some indexes perform better at specific dimensional ranges. Tree-based methods work well under twenty dimensions, while HNSW and LSH scale better to thousands of dimensions, for example.
   Memory Scaling with Dimensions: Linear growth in storage requirements per vector, but index overhead may scale differently. Product quantization effectiveness also varies with dimensionality.
   Distance Metric Considerations: Choice between L2, cosine, dot product, or other metrics affect index design. Some indexes optimize for specific distance functions.
   Computational Complexity: Distance calculations scale linearly with dimensions, making dimension reduction techniques (PCA, random projections) important for performance optimization.

Leveraging WHERE statement predicates to add additional details for index selection may also be implemented. For example, an example request may include “Select * from table WHERE text like “Question” and DATE between (sysdate and sysdate-30).” The additional “DATE” statement provides additional information that may be used in index selection. In particular, additional predicates allow the RDBMS 104 to add one additional simplification step that involve determining if there is a smaller index built based on the fact that a user is only interested in finding similarity across data from given point of time and is not looking to search a full index (even if the index could make partition elimination based on the specific clustering details).

Using these concepts, FIG. 7 is an operational flow diagram of the index selection (614) of FIG. 6. In one example, once the determination that a similarity search is desired (610), the RDBMS 104 may identify all built vector indexes 508 (700). If there is no list of indexes (702), a full text search on the vectorized data 502 identified in the request is performed (612). Even if there is no list, the index selection (614) may still begin due to the predicates contained in the request. In other examples, (700) and (702) may be integrated in the parsing (608).

If a list of indexes exists (one or more indexes 508) (702), the index list may be filtered based on additional WHERE conditions (704), as previously discussed. After filtering, the RDBMS 104 may determine if any indexes should still be considered (706). If filtering (704) removes all indexes from consideration, the filtering may be removed (708). If the list contains one or more indexes 508 (706) or the filtering has been removed (708), the classification associated with the request may be retrieved (710). The classification associated with the request provides a level of detail about which indexes 508 may qualify as potential candidates based on the request. For example, the source of the request (e.g. department, individual, etc.) may be tied to certain indexes. In other examples, all created indexes may be evaluated.

Once those indexes 508 are identified (710), the metadata associated with the identified indexes 508 is retrieved (712). As described above, various types of metadata may be maintained for the indexes (508). Index recommendation may be performed based on the various types of metadata listed. The RDBMS 104 may evaluate each index 508 as applied to the request in order to determine the optimal index 508. The goal is to identify the index 508 that will provide the “best” response in terms of performance and/or accuracy.

While various embodiments of the disclosure have been described, it will be apparent to those of ordinary skill in the art that many more embodiments and implementations are possible within the scope of the disclosure. Accordingly, the disclosure is not to be restricted except in light of the attached claims and their equivalents.

I claim:

1. A system comprising:
a storage device configured to store vectorized data representative of a set of data;
at least one processor in communication with the storage device, the at least one processor configured to:
receive a request on the vectorized data;
determine if a plurality of indexes on the vectorized data exist;
in response to the determination of existence of at least one index on the vectorized data, select an index from the plurality of indexes based on characteristics of each index of the plurality of indexes as applied to the request; and
execute the request using the selected index.

2. The system of claim 1, wherein the at least one processor is further configured to:
identify metadata associated with each of the plurality of indexes;
perform a comparison of the metadata associated with each of the plurality of indexes; and
select the index based on comparison of the metadata.

3. The system of claim 2, wherein the metadata comprises at least one of: index type, memory usage; quality, performance and dimensionality.

4. The system of claim 1, wherein the at least one processor is further configured to:
parse the request;
determine that a similarity search part of the request; and
in response to the determination that the similarity search is part of the request, determine if a plurality of indexes on the vectorized data exist.

5. The system of claim 4, where the at least one processor is further configured to perform a full text search on the vectorized data when the similarity search is absent from the request.

6. The system of claim 1, wherein the at least one processor is further configured to:
identify at least one WHERE clause in the request;
filter the plurality of indexes based on the at least one WHERE statement to a reduced number of indexes of the plurality of indexes; and
select the index from the reduced number of indexes.

7. A method comprising:
receiving, with a processor, a request on the vectorized data stored in a storage device;
determine, with the processor, if a plurality of indexes on the vectorized data exist;
in response to the determination of existence of at least one index on the vectorized data, select, with the processor, an index from the plurality of indexes based on characteristics of each index of the plurality of indexes as applied to the request; and
executing, with the processor, the request using the selected index.

8. The method of claim 7, further comprising:
identifying, with the processor, metadata associated with each of the plurality of indexes;
performing, with the processor, a comparison of the metadata associated with each of the plurality of indexes; and
selecting, with the processor, the index based on comparison of the metadata.

9. The system of claim 8, wherein the metadata comprises at least one of: index type, memory usage; quality, performance and dimensionality.

10. The system of claim 7, further comprising:
parsing, with the processor, the request;
determining, with the processor, that a similarity search part of the request; and
in response to the determination that the similarity search is part of the request, determining, with the processor, if a plurality of indexes on the vectorized data exist.

11. The system of claim 10, further comprising performing, with the processor, a full text search on the vectorized data when the similarity search is absent from the request.

12. The system of claim 8, wherein the at least one processor is further configured to:
identifying, with the processor, at least one WHERE clause in the request;
filtering, with the processor, the plurality of indexes based on the at least one WHERE statement to a reduced number of indexes of the plurality of indexes; and
selecting, with the processor, the index from the reduced number of indexes.

13. A non-transitory computer-readable medium encoded with a plurality of instructions executable by a processor, the plurality of instructions comprising:
instructions to receive a request on vectorized data stored in a storage device;
instructions to determine if a plurality of indexes on the vectorized data exist;
instructions to select, in response to the determination of existence of at least one index on the vectorized data, an index from the plurality of indexes based on characteristics of each index of the plurality of indexes as applied to the request; and
instructions to execute the request using the selected index.

14. The non-transitory computer-readable medium of claim 13, wherein the plurality of instructions further comprises:
instructions to identify metadata associated with each of the plurality of indexes;
instructions to perform a comparison of the metadata associated with each of the plurality of indexes; and
instructions to select the index based on comparison of the metadata.

15. The non-transitory computer-readable medium of claim 14, wherein the metadata comprises at least one of: index type, memory usage; quality, performance and dimensionality.

16. The non-transitory computer-readable medium of claim 13, wherein the plurality of instructions further comprises:
instructions parse the request;
instructions to determine that a similarity search part of the request; and
in response to the determination that the similarity search is part of the request, instructions to determine if a plurality of indexes on the vectorized data exist.

17. The non-transitory computer-readable medium of claim 16, wherein the plurality of instructions further comprises instructions to perform a full text search on the vectorized data when the similarity search is absent from the request.

18. The non-transitory computer-readable medium of claim 13, wherein the plurality of instructions further comprises
instructions to identify at least one WHERE clause in the request;
instructions to filter the plurality of indexes based on the at least one WHERE statement to a reduced number of indexes of the plurality of indexes; and
instructions to select the index from the reduced number of indexes.
